(19) United States
(12) Patent Application Publication
(10) Pub. No.: US 2026/0116300 A1
(43) Pub. Date: Apr. 30, 2026

(54) REFLECTOR OPTIC USED FOR FULL DISPLAY MIRROR THAT HAS AN IN-CABIN MONITORING SYSTEM

(71) Applicant: Gentex Corporation, Zeeland, MI (US)

(72) Inventors: Kasen Keith Anderson, Jenison, MI (US); Steven J. Veenman, Hudsonville, MI (US); Michael F. Lisowski, Holland, MI (US)

(73) Assignee: Gentex Corporation, Zeeland, MI (US)

(21) Appl. No.: 19/156,126

(22) PCT Filed: Feb. 20, 2025
(86) PCT No.: PCT/IB2025/051844

§ 371 Date: Aug. 13, 2025

Related U.S. Application Data
(60) Provisional application No. 63/560,076, filed on Mar. 1, 2024.

(51) Int. Cl. B60R 1/12; B60R 1/04; B60R 22/48

(52) U.S. Cl. CPC B60R 1/1207; B60R 1/04; B60R 22/48; B60R 2001/1253; B60R 2022/4866

(57) ABSTRACT

A rearview mirror assembly includes a primary housing that has an upper edge and a lower edge. A chin housing extends from the lower edge. A glass element is coupled to the primary housing and defines a viewing surface. A first printed circuit board (PC B) is located in the primary housing. A monitoring system includes an image capturing module and an illuminator that is connected to the first PCB proximate the lower edge of the primary housing. A reflective optic is at least partially located in the chin housing, the reflective optic is aligned with the illuminator and configured to redirect and spread a light from the illuminator within an interior cabin of an automobile.

### CROSS-REFERENCE TO RELATED APPLICATION

This application claims priority to and the benefit under 35 U.S.C. § 119(e) of U.S. Provisional Ser. No. 63/560,076 , filed on Mar. 1, 2024, entitled “REFLECTOR OPTIC USED FOR FULL DISPLAY MIRROR THAT HAS AN IN-CABIN MONITORING SYSTEM,” by Kasen Keith Anderson et al., the entire disclosure of which is incorporated herein by reference.

### FIELD OF THE DISCLOSURE

The present disclosure generally relates to a rearview mirror assembly and, more particularly, to a rearview mirror assembly with a monitoring system that includes an optical element for redirecting and spreading a light from an illuminator.

### SUMMARY OF THE DISCLOSURE

According to one aspect of the present disclosure, a rearview mirror assembly includes a primary housing that has an upper edge and a lower edge. A chin housing extends from the lower edge. A glass element is coupled to the primary housing and defines a viewing surface. A first printed circuit board (PCB) is located in the primary housing. A monitoring system includes an image capturing module and an illuminator that is connected to the first PCB proximate the lower edge of the primary housing. A reflective optic is at least partially located in the chin housing, the reflective optic is aligned with the illuminator and configured to redirect and spread a light from the illuminator within an interior cabin of an automobile.

According to another aspect of the present disclosure, a rearview mirror assembly includes a primary housing that has an upper edge and a lower edge. A chin housing extends from the lower edge. A glass element is coupled to the primary housing and defines a viewing surface. A monitoring system includes an image capturing module configured to capture images and an illuminator. The illuminator is proximate the lower edge of the primary housing and configured to generate illumination substantially in an infrared spectrum that is captured in the images from the image capturing module. A reflective optic includes a plurality of optical column surfaces and is at least partially located in the chin housing. The reflective optic is aligned with the illuminator and configured to redirect and spread a light from the illuminator towards an occupant seating area.

According to yet another aspect of the present disclosure, a rearview mirror assembly includes a primary housing that has an upper edge and a lower edge. A chin housing extends from the lower edge. A glass element is coupled to the primary housing and defines a viewing surface. A monitoring system includes an image capturing module configured to capture images and a plurality of illuminators. The plurality of illuminators is proximate the primary housing and configured to generate illumination substantially in an infrared spectrum that is captured in the images from the image capturing module. At least one reflective optic includes a plurality of optical column surfaces and is at least partially located in the chin housing. Each of the plurality of optical column surfaces defines a first angle directing the illumination towards a middle region of the interior cabin and a second angle directing the illumination towards a lower region of the interior cabin.

The present disclosure generally provides a monitoring system with a plurality of illuminators configured to generate an illumination that is at least partially redirected by at least one reflective optic. The at least one reflective optic includes one or more optical surfaces that can be utilized for distributing the illumination in and around the cabin to enable the monitoring system to detect activity in multiple regions within the cabin. By enabling the monitoring system to detect activity in multiple regions within the cabin, the at least one reflective optic can be beneficial for a reduction of part requirements (e.g., the number of illuminators) and packaging limitations (e.g., the location and space requirements of the illuminators).

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an interior view of a vehicle that includes a rearview mirror assembly in accordance with an aspect of the present disclosure;

FIG. 2 is a front, partially schematic view of a rearview mirror assembly in accordance with an aspect of the present disclosure;

FIG. 3A is an enlarged side perspective view of a reflective optic in a rearview mirror assembly in accordance with an aspect of the present disclosure;

FIG. 3B is an enlarged front perspective view of a reflective optic in a rearview mirror assembly in accordance with an aspect of the present disclosure;

FIG. 4 is a cross-sectional side view of a rearview mirror assembly in accordance with an aspect of the present disclosure; and

FIG. 5 is a schematic view of a control system of a rearview mirror assembly in accordance with an aspect of the present disclosure.

### DETAILED DESCRIPTION

The present illustrated embodiments reside primarily in combinations of method steps and apparatus components related to a rearview mirror assembly and, more particularly, to a rearview mirror assembly with a monitoring system that includes an optical element for redirecting and spreading a light from an illuminator. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

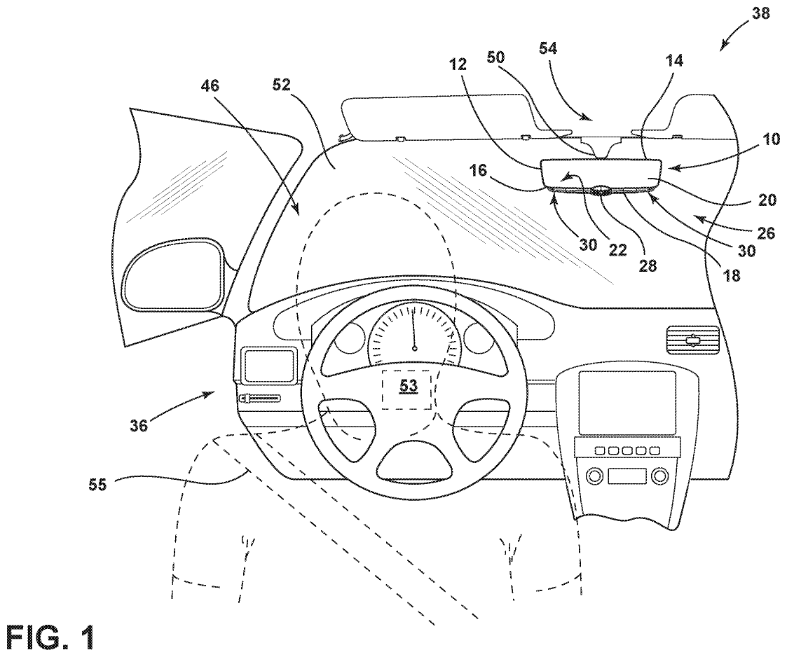

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

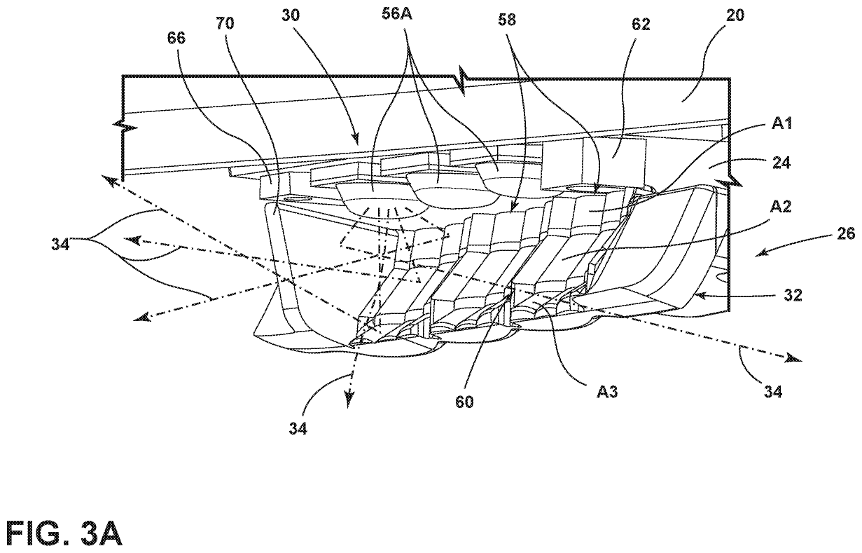

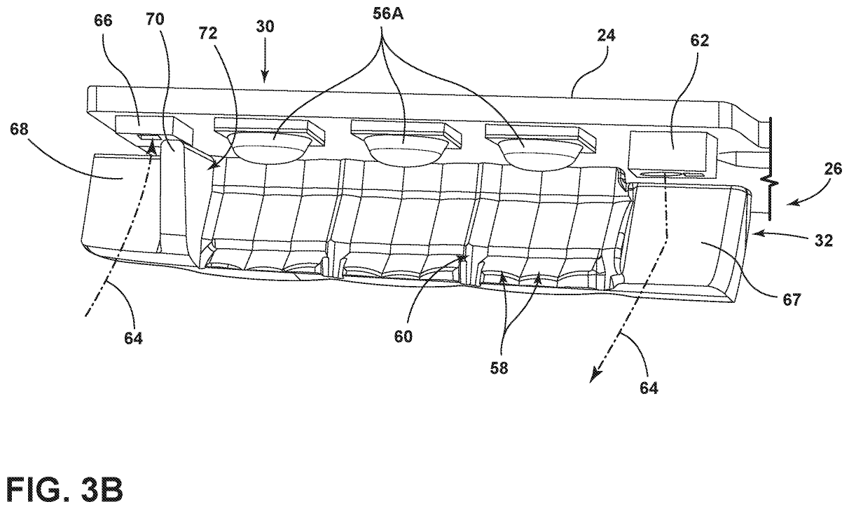

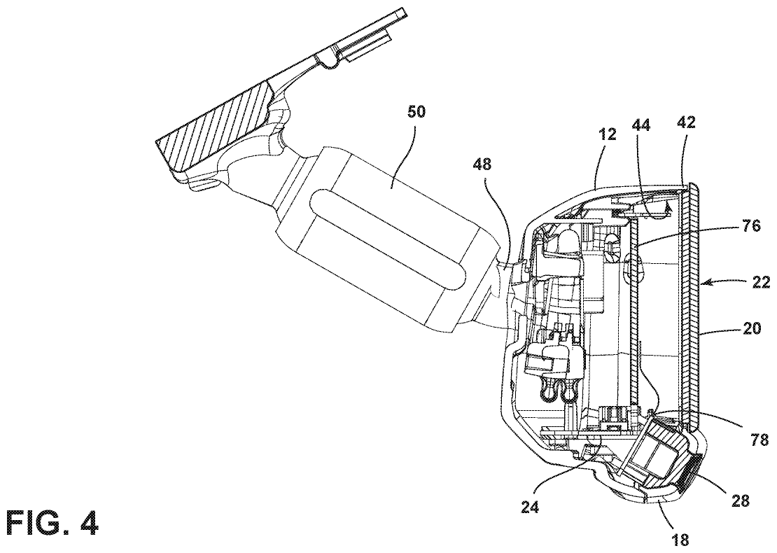

Referring to FIGS. 1-4, reference numeral 10 generally designates a rearview mirror assembly. The rearview mirror assembly 10 includes a primary housing 12 that has an upper edge 14 and a lower edge 16. A chin housing 18 extends from the lower edge 16. A glass element 20 is coupled to the primary housing 12 and defines a viewing surface 22. A first printed circuit board 24 (PCB) is located in the primary housing 12 (FIG. 4). A monitoring system 26 includes an image capturing module 28 and an illuminator 30 that is connected to the first PCB 24 proximate the lower edge 16 of the primary housing 12. A reflective optic 32 is at least partially located in the chin housing 18, the reflective optic 32 (FIGS. 3A and 3B) is aligned with the illuminator 30 and configured to redirect and spread a light 34 from the illuminator 30 within an interior cabin 36 of an automobile 38.

With continued reference to FIGS. 1-4, the monitoring system 26 may be described as a driver monitoring system (“DMS”), an in-cabin monitoring system (“ICMS”), or generally as a monitoring system that incorporates one or both of the DMS and ICMS functionalities. The configuration of the rearview mirror assembly 10 permits coupling the illuminator 30 to the first PCB 24 and redirecting and spreading the light 34. In this manner, the illuminator 30 does not need any designated PCB other than the PCB 24, which may be configured to operate various other components of the rearview mirror assembly 10. While the rearview mirror assembly 10 is depicted and largely defined as being incorporated in a rearview mirror for the automobile 38, the rearview mirror assembly 10 may be incorporated into other environments. For example, in some embodiments, components of the rearview mirror assembly 10 may be incorporated in an emergency vehicle, a residential vehicle, an airplane, a rail vehicle, or the like. Generally speaking, the rearview mirror assembly 10 may be incorporated into any environment wherein monitoring the occupant position 46 may be beneficial. The rearview mirror assembly 10 may be configured as a full display rearview mirror and include a display module 40 behind the glass element 20 and within the primary housing 12. The display module 40 may be configured to generate messages, images, and/or the like to a vehicle operator. The display module 40 may occupy the entire (i.e., substantially match the perimeter) of the glass element 20. In some embodiments, the glass element 20 may include an electrochromic component 41, such as an electrochromic medium located between a pair of opposing substrates. The electrochromic medium may be switchable between a substantially transmissive state, a substantially darkened or opaque state, and intermediary states. In some embodiments, one or more reflective layer is located in or proximate to the glass element 20 for operating as a mirror.

With reference now to FIG. 1, the primary housing 12 of the rearview mirror assembly 10 may include and/or otherwise define a bezel portion 42 that surrounds an opening 44 (FIG. 4) for locating and securing the glass element 20. However, it should be appreciated that, in some implementations, the bezel portion 42 may not be present and the primary housing 12 may be otherwise coupled to a rear surface of the glass element 20. The glass element 20 includes the viewing surface 22 that faces the occupant position 46 and a rear surface that generally faces away from the occupant position 46 within the interior cabin 36. The primary housing 12 may include a connection hub 48 and the connection hub 48 may be coupled to a mounting member 50. The mounting member 50 is configured to be coupled to the automobile 38 (e.g., a front window 52 or overhead area 54) and the primary housing 12 is moveable relative to the mounting member 50 to orient the glass element 20 at various angles relative to an occupant position 46 to obtain different environmental views and/or orientations relative to the interior cabin 36. As will be described in greater detail below, the monitoring system 26 may be configured to capture, detect, and utilize information (e.g., from the image capturing module 28 and light 34) and modify certain vehicular settings and/or generate certain warnings, such as settings or notifications related to an airbag 53, settings or notifications related to a condition of a seatbelt 55, etc.

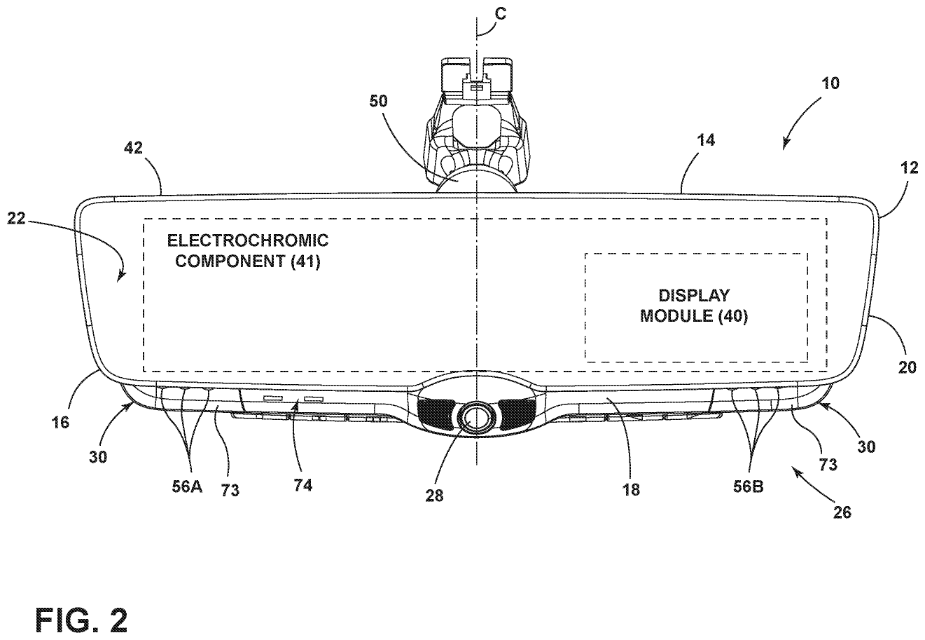

With reference now to FIGS. 2-3B, in some embodiments, the illuminator 30 includes a first plurality of light modules 56A (e.g., one, two, three, or more light modules 56A) and a second plurality of light modules 56B (e.g., one, two, three, or more light modules 56B) disposed on opposite sides of the lower edge 16. It should be appreciated that the first PCB 24 may be singular and/or multiple (e.g., to control different pluralities of light modules 56A, 5B). The image capturing module 28 may be located centrally (e.g., substantially centrally) between the first plurality of light modules 56A and the second plurality of light modules 56B. Each of the first and second plurality of light modules 56A, 56B may include a discrete one of the reflective optics 32. In this manner, each of the reflective optics 32 may be a mirror reflection of the other along a central line “C” along the rearview mirror assembly 10. However, it should be appreciated that, in other implementations, each of the reflective optics 32 may be asymmetrical and not mirrored (e.g., located in the same general orientation with respect to the rearview mirror assembly 10). Further, in some implementations, each reflective optic 32 may be generally configured to redirect light across substantially the cabin 36 (e.g., in the front seat region that includes a driver and passenger area and/or a rear seat region that includes passenger areas). As such, as the light 34 is distributed by the reflective optics 32, the distribution may be substantially similar and/or dissimilar along a horizontal axis (e.g., from a floor to ceiling of a vehicle) and a vertical axis (e.g., in a cross-car direction).

With continued reference to FIGS. 2-3B, the reflective optics 32 each include a plurality of optical column surfaces 58, each of the plurality of optical column surfaces 58 define rows that define a first angle “A1” directing the light 34 towards a middle region of the interior cabin 36 and/or an area of an occupant position 46 associated with an occupant midsection and a second row defining a second angle “A2” directing the light 34 towards a mid-upper region of the interior cabin 36 and/or an area of an occupant position 46 associated with an upper torso and a head. In some embodiments, the plurality of optical column surfaces 58 may each further include a third row defining a third angle “A3” directing the light 34 towards an upper region of the interior cabin 36 and/or an area of an occupant position 46 associated with the head. It should be appreciated that the third angle A3 may be located, shaped, and sized (e.g., a depth of the reflective element 32) such that the light 34 reflected therefrom bypasses a bottom edge of the rearview mirror assembly 10 (e.g., the primary housing 12) to reflect at an upward angle towards a ceiling of the interior cabin 36. In the reflective optics 32 depicted in FIGS. 3A and 3B, the first angle A1 is located closest to the illuminator 30, the third angle A3 is located furthest from the illuminator 30, and the second angle A2 is located between the first and third angles A1, A3. It should be appreciated that the redirection and spread of light 34 from the optical column surfaces 58 may overlap one another within angles A1-A3, such that there are not breaks in illumination. In some embodiments, the illuminator 30 and the reflective optic 32 are respectively located and sized (e.g., a depth of the reflective element 32) such that at least a portion of the light 34 bypasses the reflective optic 32 towards a lower portion of the interior cabin 36 and/or an area of an occupant position 46 associated with legs of lower body portions of an occupant. In some embodiments, each of the optical column surfaces 58 is convex for distributing the light 34 in a cross-car direction. In this manner, the reflective optics 32 generally distribute the light 34 around substantially an entirety of the occupant position 46 and at least some of the light 34 may overlap. In some embodiments, the plurality of optical column surfaces 58 may be in groupings (e.g., of two, three, or more optical column surfaces 58). In some embodiments, each grouping is separated by optical buffers 60. Further, each grouping may be contoured (e.g., concave, convex, aspheric, parabolic, and/or combinations thereof) for further tuning of the light 34 distribution. Generally speaking, the reflective optics 32 and angles A1-A3 thereof may be configured to illuminate the substantially entire interior cabin 36 (i.e., a portion of the interior cabin 36 that the rearview mirror assembly 10 is facing). More particularly, the reflective optic 32 may be configured to distribute light 34 in a substantially uniform horizontal projection across the interior cabin 36 (e.g., greater than 140 degrees). In this manner, the rearview mirror assembly 10 can be implemented in both right-hand drive and left-hand drive vehicles. Moreover, while the depicted arrangement includes three different angles A1-A3, it should be appreciated that fewer or more angles may be employed. In other words, the reflective optics 32 may include at least one angle, at least two angles, at least three angles, or more (e.g., 1 to N angles). Further, it should be appreciated that the reflective optics 32 may alternatively or in addition to angle, include one or more convex or concave curves that distribute light.

With reference now to FIGS. 3A and 3B, the rearview mirror assembly 10 may further include a proximity emitter 62 for emitting light 64 and a proximity sensor 66 (i.e., a single pixel light sensor) that receives the light 64. In some embodiments, the proximity emitter 62 and the proximity sensor 66 are operably connected to the first PCB 24. In some embodiments, the proximity emitter 62 and the proximity sensor 66 are both proximate the lower edge 16 of the primary housing 12 and the illuminator 30. More particularly, in some implementations, each reflective optic 32 may include one of the proximity emitter 62 and the proximity sensor 66. For example, the reflective optics 32 may each include an emitter surface 67 for reflecting the light 64 onto the scene and a reflector surface 68 aligned with the proximity sensor 66 for reflecting light 64 towards the proximity sensor 66. The proximity emitter 62 and the proximity sensor 66 are present to quantify an amount of the light 64 that is reflected from the occupant. The quantity of light 64 that is received by the proximity sensor 66 can be used to extrapolate a depth or distance of the occupant is from the rearview mirror assembly 10. In this manner, as the occupant moves towards the rearview mirror assembly 10, the proximity sensor 66 receives a greater amount of reflected light 64.

The amount of reflected light may be compared to a threshold quantity or count (e.g., over a predetermined amount of time), where, once the threshold is met, the illuminator 30 may be disengaged or at least partially de-energized to reduce or eliminate the amount of light 34 projected onto the occupant. Further, while disengaged, the proximity emitter 62 may continue to operate until the threshold returns below the threshold, where the illuminator 30 may be reactivated. The reflector surface 68 may be at least partially optically isolated from the plurality of optical column surfaces 58 and/or ambient lighting by a wall 70 located therebetween. The wall 70 may include a surface 72 facing the optical column surfaces 58 that is reflective and reflects the light 34 from the illuminator 30 in a cross-car direction. In this manner, the light 34 from the first plurality of light modules 56A is reflected in a general direction as the second plurality of light modules 56B and the light 34 from the second plurality of light modules 56B is reflected in a general direction as the first plurality of light modules 56A. The wall 70 may be utilized to separate light from the proximity emitter 62. In this way, the threshold determination can be performed by blocking the light 64 (i.e., with the wall 70) directly from the proximity emitter 62, such that the proximity sensor 66 is only measuring (e.g., via captured light counts) the light 64 that has been reflected. In some embodiments, the light 64 from the proximity emitter 62 and the light 34 from the illuminator 30 are both flood illumination substantially in an infrared spectrum. The plurality of light modules 56A, 56B, the reflective optic 32, the proximity emitter 62, and the proximity sensor 66 may be located in a cover 73 (FIG. 2). The cover 73 may be substantially transparent to light/illumination in the infrared or substantially infrared spectrum. In some embodiments, the cover 73 may be substantially opaque in the visible spectrum.

The plurality of optical column surfaces 58 and optical buffers 60 may be generally shaped to redirect and spread at least a portion of the light 34 within desired regions of the cabin 36. For example, the light 34 may be directed towards the passenger region, the driver region, a foot region, torso region, head region, lap region, front seat region, back seat region, and/or a region of the airbag 53. In some implementations, the image capturing module 28 may be oriented along an axis that is at least partially aimed toward the passenger region. In this manner, if the rearview mirror assembly 10 is oriented toward the driver, the image capturing module 28 is still oriented to capture the foot region and/or the region of the airbag 53. It should be appreciated, however, that the depicted arrangement is for left-handed vehicles (e.g., with a steering wheel on the right-hand side). The orientation of the image capturing module 28, and the structures of the reflective optic 32 (e.g., the optical column surfaces 58 and optical buffers 60) may be mirrored (e.g., reversed) in the opposite direction for right-handed vehicles.

With reference now to FIG. 4, the rearview mirror assembly 10 includes the first PCB 24 which may transverse (e.g., substantially perpendicular) to the viewing surface 22. The first PCB 24 may be operably connected to the illuminator 30, the proximity emitter 62, and the proximity sensor 66. In some embodiments, the chin housing 18 or other areas of the rearview mirror assembly 10 may include a user interface 74 (FIG. 2) operably connected to the first PCB 24. In some embodiments, the rearview mirror assembly 10 may further include a second PCB 76 that is operably connected to other components of the rearview mirror assembly 10. For example, the second PCB 76 may be operably connected to the display module 40 and electrochromic components. The second PCB 76 may be transverse to the first PCB 24 (e.g., substantially parallel to the viewing surface 22). In some embodiments, the second PCB 76 may be configured or referred to as the main PCB. In some embodiments, the image capturing module 28 includes a designated imager or third PCB 78.

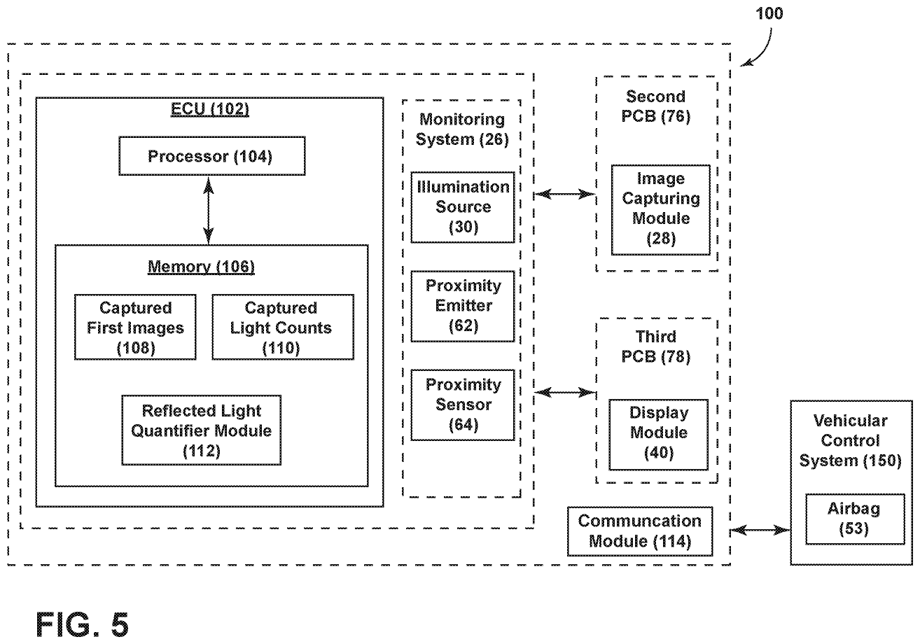

With reference now to FIG. 5, a control system 100 of the rearview mirror assembly 10 may include at least one electronic control unit (ECU) 102. The at least one ECU 102 may be located in the primary housing 12 and may be associated with the first PCB 24, the second PCB 76, the third PCB 78, and/or combinations thereof. In some embodiments, components of the ECU 102 are located in both the primary housing 12, the chin housing 18, and/or other structures in the automobile 38. The at least one ECU 102 may include a processor 104 and a memory 106. The processor 104 may include any suitable processor 104. Additionally, or alternatively, each ECU 102 may include any suitable number of processors, in addition to or other than the processor 104. The memory 106 may comprise a single disk or a plurality of disks (e.g., hard drives) and includes a storage management module that manages one or more partitions within the memory 106. In some embodiments, memory 106 may include flash memory, semiconductor (solid state) memory, or the like. The memory 106 may include Random Access Memory (RAM), a Read-Only Memory (ROM), Electrically Erasable Programmable Read-Only Memory (EEPROM), or a combination thereof. The memory 106 may include instructions that, when executed by the processor 104, cause the processor 104 to, at least, perform the functions associated with the components of the rearview mirror assembly 10. The illuminator 30, the proximity emitter 62, the proximity sensor 66, the user interface 74, the display module 40, the electrochromic components, and/or the image capturing module 28 may, therefore, be controlled by the control system 100. The memory 106 may, therefore, include a series of captured first images 108, a series of captured light counts 110, and a reflected light quantifier module 112. In some embodiments, the control system 100 may alternatively and/or additionally include one or more logic circuits configured to carry out the functionalities described herein. In some embodiments, the control system 100 may include a communication module 114 in operable communication with a vehicular control system 150.

In operation, the illuminator 30 and the proximity emitter 62 may be sequenced. In this manner, the image capturing module 28 captures images (i.e., the captured first images 108) while the illuminator 30 is energized and the proximity sensor 66 captures images (i.e., the captured light counts 110) while the proximity emitter 62 is energized. As previously detailed, the proximity emitter 62 and the proximity sensor 66 may be utilized (e.g., via the reflected light quantifier module 112) to quantify an amount of the light 64 that is reflected from the occupant. The quantity of light 64 (as measured in captured light counts 110) that is received by the proximity sensor 66 can be used to extrapolate (e.g., via the control system 100 or processor 104 reviewing the captured light counts 110) if the occupant has entered a region relative to the rearview mirror assembly 10 to turn off or de-energize the illuminator 30. In this manner, as the captured light counts 110 go over a threshold (e.g., during a predetermined amount of time), the illuminator 30 may be disengaged or at least partially de-energized (e.g., via the control system 100 or processor 104) to reduce or eliminate the amount of light 34 projected onto the occupant. The first captured images 108, on the other hand, may be utilized for driver monitoring functionality, such as monitoring physical attributes, locations, and other characteristics of vehicle occupants.

With continued reference to FIG. 5, the control system 100 may be configured to review the captured images 108 and monitor passenger or driver activity with respect to the region of the airbag 53 and/or the status of the seatbelt 55. While the proceeding examples use the passenger as an example, the same principles can be utilized for driver monitoring. For example, if the passenger is in contact with the region of the airbag 53, the control system 100 may (e.g., via the communication module 114) generate a signal (e.g., via the communication module 114) to the vehicular control system 150 to prevent deploying the airbag 53. Further, if the passenger is in contract with or within a proximity threshold, the control system 100 may be configured to generate a warning (audible and/or visual) to request the passenger move within a safe position with respect to the airbag 53 (e.g., outside the proximity threshold). In some implementations, the monitoring system 26 (e.g., the control system 100) is configured to regulate the deployment of the airbag 53 between a maximum deployment (e.g., when the passenger is outside the proximity threshold), a minimum deployment, and intermediary deployments. For example, when a passenger is within the proximity threshold but not in contact with the region of the airbag 53 (e.g., the surface defining the deployment origin), the minimum deployment and/or intermediary deployment may be utilized via communication with the vehicular control system 150. In some implementations, the deployment may be directly correlated to the occupant's distance to the airbag 53, where the closer the passenger is to the airbag 53, the lower the deployment. In a similar manner, if the passenger or driver is not wearing or improperly wearing the seatbelt 55, the control system 100 may (e.g., via the communication module 114) generate a warning or otherwise generate a signal (e.g., via the communication module 114) to the vehicular control system 150 to generate a warning and may further modify the deployment of the airbag 53.

The disclosure herein is further summarized in the following paragraphs and is further characterized by combinations of any and all of the various aspects described therein.

According to one aspect of the present disclosure, a rearview mirror assembly includes a primary housing that has an upper edge and a lower edge. A chin housing extends from the lower edge. A glass element is coupled to the primary housing and defines a viewing surface. A first printed circuit board (PCB) is located in the primary housing. A monitoring system includes an image capturing module and an illuminator that is connected to the first PCB proximate the lower edge of the primary housing. A reflective optic is at least partially located in the chin housing, the reflective optic is aligned with the illuminator and configured to redirect and spread a light from the illuminator within an interior cabin of an automobile.

According to another aspect, a reflective optic includes a plurality of optical column surfaces, the plurality of optical column surfaces each include rows defining a first angle directing a light towards a middle region of an interior cabin, a second angle directing the light towards a mid-upper region of the interior cabin.

According to yet another aspect, rows of a plurality of optical column surfaces include a third angle directing a light towards an upper region an interior cabin.

According to still another aspect, a first angle is located closest to an illuminator, a third angle is located furthest from the illuminator, and a second angle is located between the first and third angles.

According to another aspect, a portion of the light passes by a reflective optic towards a lower region of an interior cabin.

According to yet another aspect, an illuminator and a reflective optic are respectively located such that at least a portion of a light from the illuminators bypasses the reflective optic towards a lower portion of an occupant seating area.

According to still another aspect, each of a plurality of optical column surfaces is convex for distributing a light in a cross-car direction.

According to yet another aspect, a rearview mirror assembly includes a proximity emitter for emitting light and a proximity sensor that receives the light, each connected to a first PCB proximate a lower edge of a primary housing and an illuminator.

According to still another aspect, a reflective optic includes a reflector surface aligned with a proximity sensor for reflecting light toward the proximity sensor.

According to yet another aspect, a reflector surface is optically isolated from a plurality of optical column surfaces by a wall therebetween.

According to still another aspect, a surface of a wall facing optical column surfaces is reflective and reflects a light in a cross-car direction.

According to yet another aspect, light from a proximity emitter and a light from an illuminator are both flood illumination substantially in an infrared spectrum.

According to another aspect of the present disclosure, a rearview mirror assembly includes a primary housing that has an upper edge and a lower edge. A chin housing extends from the lower edge. A glass element is coupled to the primary housing and defines a viewing surface. A monitoring system includes an image capturing module configured to capture images and an illuminator. The illuminator is proximate the lower edge of the primary housing and configured to generate illumination substantially in an infrared spectrum that is captured in the images from the image capturing module. A reflective optic includes a plurality of optical column surfaces and is at least partially located in the chin housing. The reflective optic is aligned with the illuminator and configured to redirect and spread a light from the illuminator towards an occupant seating area.

According to another aspect, a rearview mirror assembly includes a control system configured to review the images captured by the image capturing module, detect that an occupant in the occupant seating area is within a proximity threshold from a region of an airbag, and regulate the deployment of the airbag based on the occupant's proximity.

According to yet another aspect, the control system includes a communication module configured to be in operable communication with a vehicular control system.

According to still another aspect, a rearview mirror assembly includes a control system configured to review the images captured by the image capturing module, detect that an occupant in the occupant seating area is not wearing a seatbelt, and generate a warning.

According to yet another aspect of the present disclosure, a rearview mirror assembly includes a primary housing that has an upper edge and a lower edge. A chin housing extends from the lower edge. A glass element is coupled to the primary housing and defines a viewing surface. A monitoring system includes an image capturing module configured to capture images and a plurality of illuminators. The plurality of illuminators is proximate the primary housing and configured to generate illumination substantially in an infrared spectrum that is captured in the images from the image capturing module. At least one reflective optic includes a plurality of optical column surfaces and is at least partially located in the chin housing. The plurality of optical column surfaces include rows that define a first angle directing the illumination towards a middle region of the interior cabin and a second angle directing the illumination towards a lower region of the interior cabin.

According to another aspect, the at least one reflective optic includes a first reflective optic and a second reflective optic, the first reflective optic spaced from the second reflective optic between opposite sides of the primary housing.

According to yet another aspect, the first reflective optic and the second reflective optic are both oriented relative to the plurality of illuminators to redirect and spread the illumination towards both a driver seating area and a passenger seating area.

According to still another aspect, a rearview mirror assembly includes a display module.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

1. A rearview mirror assembly comprising:
a primary housing including an upper edge and a lower edge, a chin housing extending from the lower edge;
a glass element coupled to the primary housing and defining a viewing surface;
a first printed circuit board (PCB) located in the primary housing; and
a monitoring system comprising:
an image capturing module;
an illuminator connected to the first PCB proximate the lower edge of the primary housing; and
a reflective optic at least partially located in the chin housing, the reflective optic aligned with the illuminator and configured to redirect and spread a light from the illuminator within an interior cabin of an automobile, and wherein the reflective optic includes a plurality of optical column surfaces, the plurality of optical column surfaces each include rows defining a first angle directing the light towards a middle region of the interior cabin and a second angle directing the light towards a mid-upper region of interior cabin.

2. (canceled)

3. The rearview mirror assembly of claim 1, wherein the rows of the plurality of optical column surfaces further includes a third angle directing the light towards an upper region interior cabin.

4. The rearview mirror assembly of claim 3, wherein the first angle is located closest to the illuminator, the third angle is located furthest from the illuminator, and the second angle is located between the first and third angles.

5. The rearview mirror assembly of claim 3, wherein at least a portion of the light passes by the reflective optic towards a lower region of the interior cabin.

6. The rearview mirror assembly of claim 1, wherein the illuminator and the reflective optic are respectively located such that at least a portion of the light bypasses the reflective optic towards a lower portion of an occupant seating area.

7. The rearview mirror assembly of claim 1, wherein each optical column surface is convex for distributing the light in a cross-car direction.

8. The rearview mirror assembly as of claim 1, further including a proximity emitter for emitting light and a proximity sensor that receives the light connected to the first PCB, the proximity emitter and the proximity sensor both proximate the lower edge of the primary housing and the illuminator.

9. The rearview mirror assembly of claim 8, wherein the reflective optic includes a reflector surface aligned with the proximity sensor for reflecting light towards the proximity sensor.

10. The rearview mirror assembly of claim 9, wherein the reflector surface is optically isolated from the plurality of optical column surfaces by a wall therebetween.

11. The rearview mirror assembly of claim 10, wherein a surface of the wall facing the optical column surfaces is reflective and reflects the light in a cross-car direction.

12. The rearview mirror assembly of claim 8, wherein the light from the proximity emitter and the light from the illuminator are both flood illumination substantially in an infrared spectrum.

13. A rearview mirror assembly comprising:
a primary housing including an upper edge and a lower edge, a chin housing extending from the lower edge;
a glass element coupled to the primary housing and defining a viewing surface;
a first printed circuit board (PCB) located in the primary housing; and
a monitoring system comprising:
an image capturing module configured to capture images;
an illuminator connected to the first PCB proximate the lower edge of the primary housing and configured to generate illumination substantially in an infrared spectrum that is captured in the images from the image capturing module; and
a reflective optic including a plurality of optical column surfaces and at least partially located in the chin housing, the reflective optic aligned with the illuminator and configured to redirect and spread a light from the illuminator towards an occupant seating area, and wherein the reflective optic includes a plurality of optical column surfaces, the plurality of optical column surfaces each include rows defining a first angle directing the light towards a middle region of the interior cabin and a second angle directing the light towards a mid-upper region of interior cabin.

14. The rearview mirror assembly of claim 13, further including a control system configured to:
review the images captured by the image capturing module;
detect that an occupant in the occupant seating area is within a proximity threshold from a region of an airbag; and
regulate a deployment of the airbag based on the occupant's proximity.

15. The rearview mirror assembly of claim 14, wherein the control system includes a communication module configured to be in operable communication with a vehicular control system.

16. The rearview mirror assembly of claim 13, further including a control system configured to:
review the images captured by the image capturing module;
detect that an occupant in the occupant seating area is not wearing a seatbelt; and
generate a warning.

17. A rearview mirror assembly comprising:
a primary housing including an upper edge and a lower edge;
a glass element coupled to the primary housing and defining a viewing surface; and
a monitoring system comprising:
an image capturing module configured to capture images;
a plurality of illuminators proximate the primary housing and configured to generate illumination substantially in an infrared spectrum that is captured in the images from the image capturing module; and
at least one reflective optic including a plurality of optical column surfaces and at least partially located in the chin housing, the plurality of optical column surfaces include rows defining a first angle directing the illumination towards a middle region of the interior cabin and a second angle directing the illumination towards a lower region of interior cabin.

18. The rearview mirror assembly of claim 17, wherein the at least one reflective optic includes a first reflective optic and a second reflective optic, the first reflective optic spaced from the second reflective optic between opposite sides of the primary housing.

19. The rearview mirror assembly of claim 18, wherein the first reflective optic and the second reflective optic are both oriented relative to the plurality of illuminators to redirect and spread the illumination toward both a driver seating area and a passenger seating area.

20. The rearview mirror assembly of claim 17, further including a display module located in the primary housing.
